(19) United States
(12) Patent Application Publication
(10) Pub. No.: US 2012/0143741 A1
(43) Pub. Date: Jun. 7, 2012

(54) SYSTEMS AND METHODS FOR CONTROLLING ELECTRONIC EXCHANGE BEHAVIOR BASED ON AN INFORMED TRADING METRIC

(75) Inventors: Marcos M. Lopez de Prado, White Plains, NY (US); Maureen P. O'Hara, Lansing, NY (US); David Easley, Lansing, NY (US)

(73) Assignee: Tudor Investment Corporation, Greenwich, CT (US)

(21) Appl. No.: 13/274,090

(22) Filed: Oct. 14, 2011

Related U.S. Application Data
(60) Provisional application No. 61/393,751, filed on Oct. 15, 2010.

(51) Int. Cl. G06Q 40/04

(52) U.S. Cl. 705/37

(57) ABSTRACT

A computerized exchange system and a method of operating a computerized exchange system are disclosed. The exchange system variably favors execution of buy trades or sell trades based on the value of an informed trading metric, thereby attempting to forestall predatory increases in order toxicity. The system includes a first network interface for receiving a plurality of securities trades, including a plurality of buy transactions and a plurality of sale transactions. A matching processor matches the securities trades to market makers. The matching processor is configured to obtain a value of the informed trading metric and to determine a buy transaction bias or a sell transaction bias based on the value of the informed trading metric. The matching processor then matches trades to market makers favoring buy transactions or sell transactions based on the determined bias. A settlement processor then settles the matched trades.

### CROSS REFERENCE TO RELATED APPLICATIONS

This application claims the benefit of U.S. Provisional Patent Application No. 61/393,751, entitled “Systems and Methods For Calculating an Informed Trading Metric and Applications Thereof,” filed on Oct. 15, 2010, the entire disclosure of which is hereby incorporated by reference as if set forth herein in its entirety.

### BACKGROUND OF THE INVENTION

On May 6, 2010, in a matter of minutes, the Dow Jones Industrial Average experienced its largest one day point decline in its history, 998.5 points. This market crash is now known as the Flash Crash. Observers have credited toxic order flow or flow toxicity as a key cause of the crash, which saw market makers exiting the market, drying up liquidity and driving down prices. Since the Flash Crash, traders, investors, and regulators have sought ways to predict such crashes in the future and prevent their occurrence if possible.

Practitioners in the securities trading field usually refer to adverse selection as the “natural tendency for passive orders to fill quickly when they should fill slowly and fill slowly (or not at all) when they should fill quickly.” This intuitive formulation is consistent with the sequential trade model proposed by Easley and O'Hara in 1992, in the paper entitled “Time and the Process of Security Price Adjustment,” published in the Journal of Finance, whereby informed traders take liquidity from uninformed traders, resulting in a transfer of wealth. Flow is regarded as toxic when it adversely selects market makers, who are unaware that they are providing liquidity at their own loss. Flow toxicity, which may have driven the Flash Crash, can be expressed in terms of Probability of Informed Trading (PIN). As used herein, the term “informed trading metric” shall refer to a metric that is indicative of PIN.

A fundamental insight of the microstructure literature is that the order arrival process contains critical information to determine subsequent price moves in general, and flow toxicity in particular. Considering the wealth of research dedicated to showing the impact of PIN on bid-ask spreads, asset returns, liquidity, market markers' participation, etc., it would only be natural to expect PIN to be a household term used by trading desks across all asset classes. However, despite nearly 20 years of research into PIN by the finance community, no practical solution has been found for estimating a value for PIN in a high frequency framework (i.e. with a regularity that matches the intraday-seasonal profile of exchange activity). Thus, a need remains in the art for systems and methods that practically and robustly generate a verifiable informed trading metric.

### SUMMARY OF THE INVENTION

As it is believed that a key factor in the Flash Crash was order toxicity, a robust system and method of measuring order toxicity could be used to predict and prevent such crashes in the future. As demonstrated herein, an informed trading metric, and in particular, certain order imbalance-based informed trading metrics have the potential for accurately representing the level of order toxicity in the market. Consequently, according to one aspect, the invention relates to an exchange system that variably favors execution of buy trades or sell trades based on the value of an informed trading metric, thereby attempting to forestall predatory trading based on elevated market levels of informed trading, or high levels of flow toxicity. The system includes a first network interface for receiving a plurality of securities trades, including a plurality of buy transactions and a plurality of sale transactions. A matching processor matches the securities trades to market makers. The matching processor is configured to obtain a value of the informed trading metric and to determine a buy transaction bias or a sell transaction bias based on the value of the informed trading metric. The matching processor then matches trades to market makers favoring buy transactions based on the determined bias. A settlement processor then settles the matched trades.

In certain embodiments, the informed trading metric includes a volume synchronized informed trading metric, an order imbalance metric, a metric indicative of a ratio of a total order imbalance to a total order volume, a forecasted order imbalance metric, or a cumulative distribution function of any of the foregoing. In certain embodiments in which the informed trading metric is based on a total order imbalance, the total order imbalance is calculated by totaling set order imbalances across a plurality of equally sized sets of trades.

In one embodiment, the securities exchange system sets a buy or sell bias based on a time for which the value of an informed trading metric exceeds a threshold. In other embodiments, the bias is set as a continuous function of the informed trading metric.

### BRIEF DESCRIPTION OF THE DRAWINGS

The methods and systems disclosed herein may be better understood from the following illustrative description with reference to the following drawings in which:

FIG. 1 is a block diagram of a system for calculating an informed trading metric, according to an illustrative embodiment of the invention.

FIG. 2 is a flow chart of a method of calculating an informed trading metric using the system of FIG. 1, according to an illustrative embodiment of the invention.

FIG. 3 is a block diagram of an exchange suitable for facilitating trades of informed trading metric-based derivative contracts, according to an illustrative embodiment of the invention.

FIG. 4 is a flow chart of a method of facilitating the exchange of informed trading metric-based derivative contracts, according to an illustrative embodiment of the invention.

FIG. 5 is a block diagram of a broker system for timing execution of trading instructions based on an informed trading metric, according to an illustrative embodiment of the invention.

FIG. 6 is a flow chart of a method of timing execution of trading instructions based on an informed trading metric, according to an illustrative embodiment of the invention.

FIG. 7 is a block diagram of a system for analyzing the performance of a trading entity, according to an illustrative embodiment of the invention.

FIG. 8 is a flow chart of a method of analyzing the performance of a trading entity, according to an illustrative embodiment of the invention.

FIG. 9 is a block diagram of variable matching rate exchange system, according to an illustrative embodiment of the invention.

FIG. 10 is a flow chart of a method of altering trade matching rates by an exchange system, according to an illustrative embodiment of the invention.

FIG. 11 is a plot illustrating empirical results comparing the informed trading metric and corresponding index values of the E-mini S&P500 futures contract.

FIG. 12 is a plot illustrating empirical results comparing the informed trading metric and corresponding index values of the WTI Crude Oil futures contract.

### DESCRIPTION OF CERTAIN ILLUSTRATIVE EMBODIMENTS

To provide an overall understanding of the invention, certain illustrative embodiments will now be described, including systems and methods for calculating an informed trading metric as well as systems and methods for various applications that utilize such a metric. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

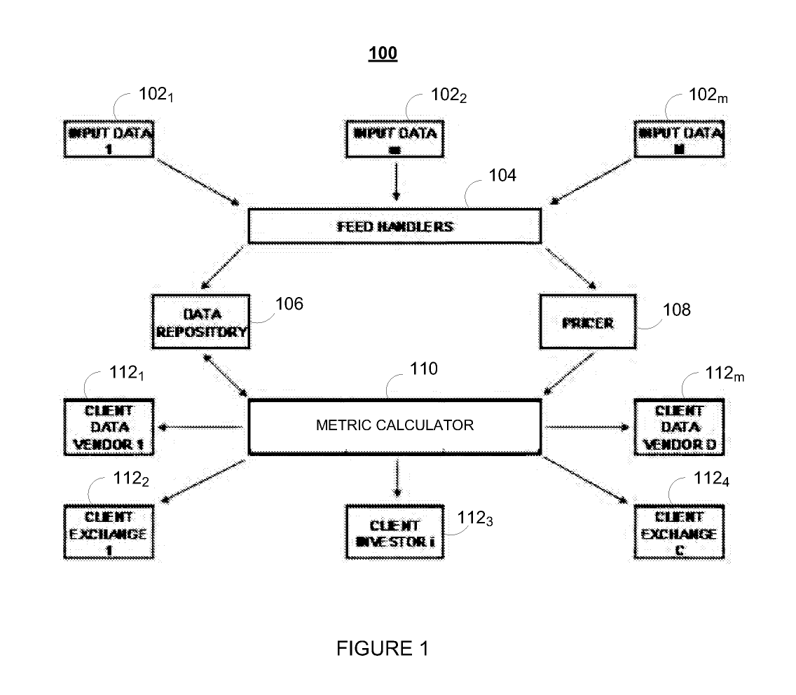

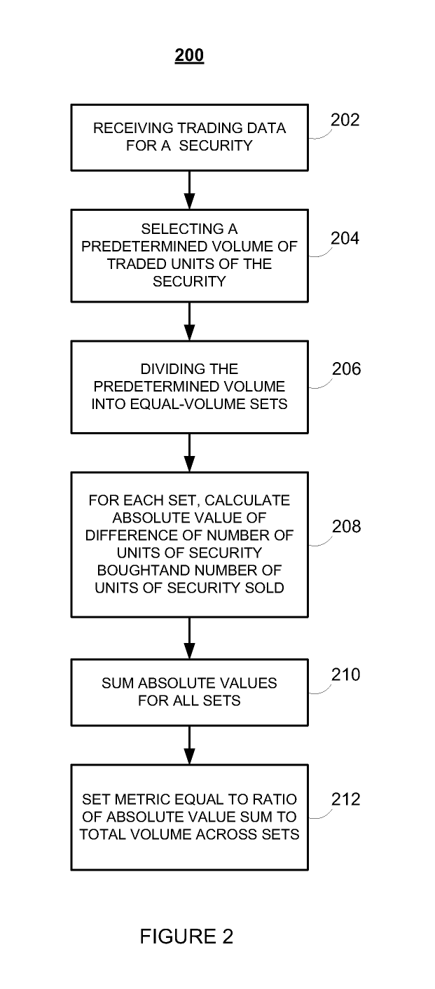

FIG. 1 is a block diagram of a system 100 for calculating an informed trading metric, according to an illustrative embodiment of the invention. According to one embodiment, the informed trading metric is a volume-synchronized probability of informed trading, referred to herein as “VPIN”. An illustrative method for calculating VPIN is described further in relation to FIG. 2.

The system 100 includes several data inputs 102ₗ-102ₘ (each a “data input 102” or collectively “data inputs 102”), feed handlers 104, a data repository 106, a pricer 108, a metric calculator 110, and data outputs 112ₗ-112ₘ (each a “data output 112” or collectively “data outputs 112”). Each of the components, in various embodiments, may be implemented in any suitable combination of computer hardware and software. For example, each component may be implemented as computer readable instructions stored on a non-transitory computer readable medium, such as a magnetic disk, optical disk, integrated circuit memory, or other form of non-transitory memory device. The computer readable instructions cause a computer processor, upon execution, to carry out the methodology described further in relation to FIG. 2.

The computer readable instructions associated with each component may be executed on a single processor, with the coordination of such execution controlled by an operating system executing on the processor. Alternatively, the components may be executed on separate processors. For example, the computer readable instructions that implement the metric calculator 110 may execute on a separate single processor, a plurality of parallel processors, or multiple distinct processors configured to operate as a computer cluster. The functionality of each component is described further below.

Each data input 102 receives a data feed from an external financial data information provider, such as a SIP (Securities Information Processor), BLOOMBERG, REUTERS, WOMBAT, QUANTHOUSE, etc. The data feeds are received, e.g., via a network interface card in communication with a network gateway that communicatively couples the system 100 to the Internet, a private Wide Area Network, or other communication network. The data feeds identify trades of securities, and include the identification of the security traded, the number of units of the security traded, the price at which the security was exchanged, and the time of the trade. In one embodiment, at least one data feed includes data indicative of trades in e-Mini S&P 500 futures contracts. This information may arise from a variety of sources such as information on underlying asset fundamentals, information on the current imbalance of suppliers and demanders for the contract, or information on future demand-supply imbalances.

Each data input 102 outputs the received data feeds into corresponding feed handlers 104. Each feed handler 104 is configured to parse a particular data feed received via a data input 102 to convert the data contained therein into a common format suitable for further processing by the system 100. The feed handlers 104 forward the processed data feeds to a data repository 106 as well as to a pricer 108. The data repository is a data base storing current and historical trading data, as well as current and historical calculated values of the informed-trading metric calculated by the system 100. The pricer 108 receives the parsed data feeds from the feed handlers 104 and publishes the data to the metric calculator 110. For implementations using a computer cluster-based metric calculator 110, the pricer 108 publishes the data to each of the computers in the cluster according to a multicast protocol, such as the LBM (Latency Busters Messaging) protocol, offered by 29WEST of Warrenville, Ill.

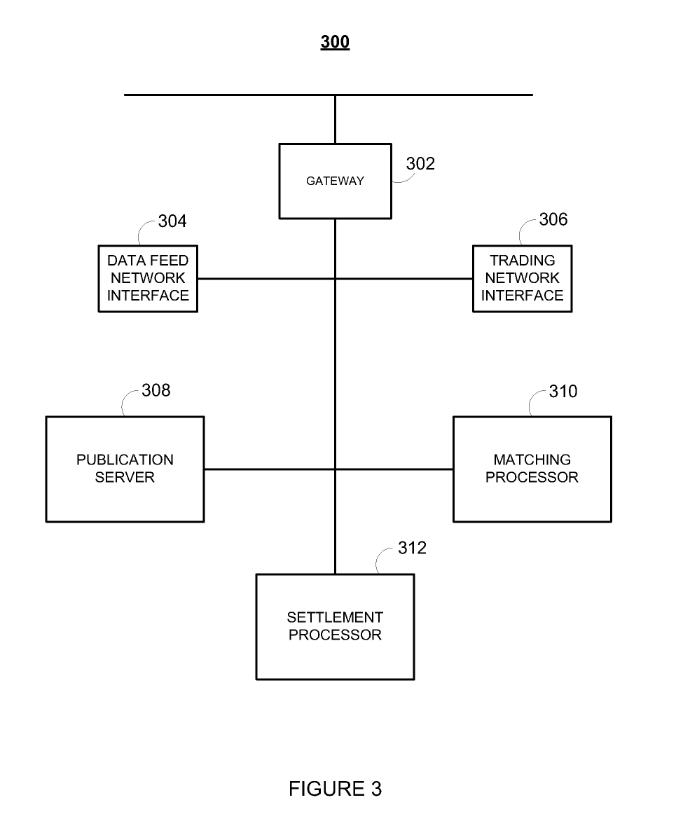

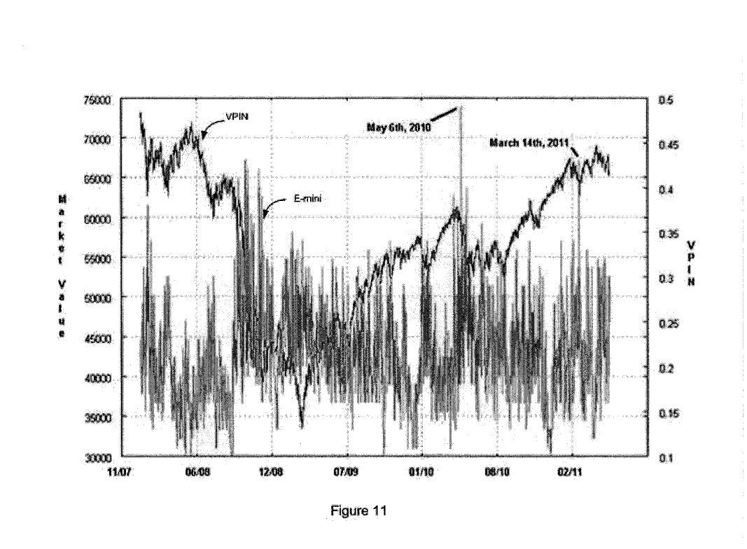

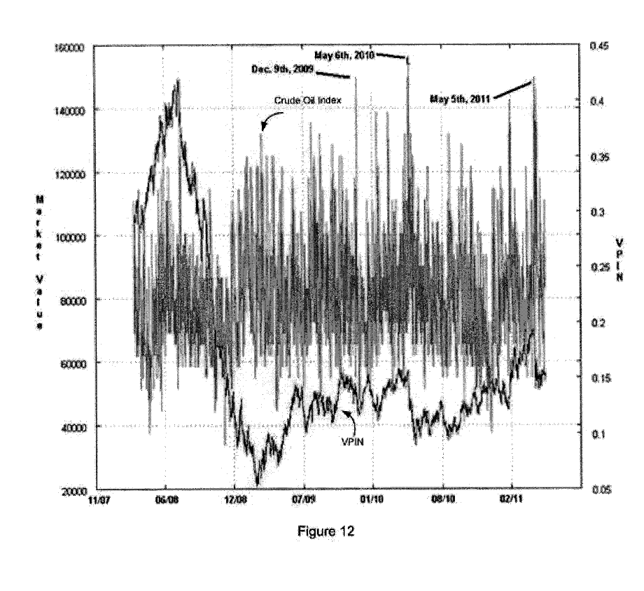

The metric calculator 110 processes the data published by the pricer 108 to calculate an informed trading metric, such as VPIN. The metric calculator 110 then outputs the resultant metric value to the data repository 106 as well as to the data outputs 112. The data outputs 112 stream informed trading metric data to various customers including securities exchanges, data providers and aggregators, brokers, investors, and analysts. The theoretical underpinnings of the informed trading metric are set forth below. A method for calculating the informed trading metric is then described in relation to FIG. 2. Systems and methods for using the informed trading metric by various types of recipients are then described further in relation to FIGS. 3-10. FIGS. 11-12 depict empirical results illustrating the informative capabilities of the informed trading metric described herein in relation to disparate asset classes.

### Theoretical Underpinnings of the Informed Trading Metric

A long position can be understood as a bet that a security's price will increase over a period of time. Similarly, a short position can be understood as a bet that a security's price will decrease over a period of time. Not all traders holding a long or short position are informed of the events that will eventually cause the price to go up or down. Traders who have no particular information about the future value of the security, denoted uninformed, will also have no particular tendency to make money on a position. On the other hand, some investors holding a long or short position do so because they hold information that ends up impacting the price up or down in a profitable manner. Such traders are referred to herein as informed traders.

Informed traders are able to monetize their information on a particular security, and so they gain from their positions in the security. Uninformed traders do not have information to monetize, and so while some will make money (if they happen to be on the same side as the informed), others will lose money. Those uninformed traders that lose money have transferred part of their wealth to either informed or uninformed traders (a phenomenon called adverse selection).

A critical type of uninformed trader is composed of market makers. Market makers are viewed as uninformed because they do not have particular information about a security's future value, but instead focus on providing liquidity to both buyers and sellers (and thereby earn the bid-ask spread). In toxic markets, because market makers choose the price of the trade but not the timing, they are the victims of adverse selection, meaning that they are providing liquidity at a loss (they have been a counterpart to so called “toxic order flow”). Should toxic order flow persist, market makers may be forced to abandon their market making activities, possibly causing a market crisis like the Flash Crash on May 6, 2010.

As uninformed traders do not act on information that is relevant to the future price of the security, their positioning can be considered somewhat arbitrary, with as many holding a long position as those holding a short position. Informed traders are the source of persistent order imbalance. In a high frequency trading world, this order imbalance should be measured in volume time rather than chronological time. It can be mathematically demonstrated that monitoring order imbalance over a number of comparable volume units, e.g., by monitoring the VPIN metric disclosed herein, makes it possible to measure the probability that informed traders are operating at a particular moment in time (PIN), thus signaling the likelihood that adverse selection may be occurring. This theory has important practical implications, as markets cannot operate efficiently in the absence of market makers.

What follows next is a more rigorous description of the concepts introduced above. For clarity the model is described in its simplest form. It will be understood by one of ordinary skill in the art that more complex descriptions of the trade process are possible.

A microstructure model can be estimated for individual stocks using trade data to determine the probability of information-based trading, PIN. This microstructure model views trading as a game between liquidity providers and traders (position takers) that is repeated over trading periods i=1, . . . , I. At the beginning of each period, nature chooses whether an information event occurs. These events occur independently with probability α. If the information is good news, then informed traders know that by the end of the trading period the asset will be worth S̅ᵢ; and, if the information is bad news, that it will be worth Sᵢ, with S̅_{i<S}ᵢ. Good news occurs with probability (1−δ) and bad news occurs with the remaining probability, δ. After an information event occurs or does not occur, trading for the period begins with traders arriving according to Poisson processes throughout the trading period. During periods with an information event, orders from informed traders arrive at rate These informed traders buy if they have seen good news, and sell if they have seen bad news. Every period orders from uninformed buyers and uninformed sellers each arrive at rate E.

The structural model relates observable market outcomes (i.e. buys and sells) to the unobservable information and order processes that underlie trading. Intuitively, the model interprets the normal level of buys and sells in a stock as uninformed trade, and it uses that data to identify the rate of uninformed order flow, ε. Abnormal buy or sell volume is interpreted as information-based trade, and it is used to identify μ. The number of periods in which there is abnormal buy or sell volume is used to identify α and δ.

A liquidity provider uses his knowledge of these parameters to determine the price at which he is willing to go long, the Bid, and the price at which he is willing to go short, the Ask. These prices differ, and so there is a Bid-Ask Spread, because the liquidity provider does not know whether the counterparty to his trade is informed or not. This spread is the difference in the expected value of the asset conditional on someone buying from the liquidity provider and the expected value of the asset conditional on someone selling to the liquidity provider. These conditional expectations differ because of the adverse selection problem induced by the possible presence of better informed traders.

As trade progresses, liquidity providers observe trades and are modeled as if they use Bayes rule to update their beliefs about the toxicity of the order flow, which in our model is described by the parameter estimates. Let P(t)=(Pₙ(t), P_{b}(t), P_{g}(t)) be a liquidity provider's belief about the events “no news” (n), “bad news” (b), and “good news” (g) at time t. His belief at time 0 is P(0)=(1−α, αδ, α(1−δ)).

To determine the Bid or Ask at time t, the liquidity provider updates his beliefs conditional on the arrival of an order of the relevant type. The time t expected value of the asset, conditional on the history of trade prior to time t, is

E[Sᵢ|t]=Pₙ(t)S*ᵢ+P_{b}(t)Sᵢ+P_{g}(t) S̅ᵢ (1)

where S*hd i=δSᵢ+(1−δ) S̅ᵢ is the prior expected value of the asset.

The Bid is the expected value of the asset conditional on someone wanting to sell the asset to a liquidity provider. So it is

$$B ( t ) = E [ {S}_{i} \vert t ] - \frac{μ {P}_{b} ( t )}{ɛ + μ {P}_{b} ( t )} ( E [ {S}_{i} \vert t ] - \underline{{S}_{i}} ) \qquad ( 2 )$$

Similarly, the Ask is the expected value of the asset conditional on someone wanting to buy the asset from a liquidity provider. So it is

$$A ( t ) = E [ {S}_{i} \vert t ] + \frac{μ {P}_{g} ( t )}{ɛ + μ {P}_{g} ( t )} ( {\overline{S}}_{i} - E [ {S}_{i} \vert t ] ) \qquad ( 3 )$$

These equations demonstrate the explicit role played by arrivals of informed and uninformed traders in affecting quotes. If there are no informed traders (μ=0), then trade carries no information, and so the Bid and Ask are both equal to the prior expected value of the asset. Alternatively, if there are no uninformed traders (ε=0), then the Bid and Ask are at the minimum and maximum prices, respectively. At these prices no informed traders will trade either, and the market, in effect, shuts down. Generally, both informed and uninformed traders will be in the market, and so the Bid is less than E [Sᵢ|t] and the Ask is greater than E[Sᵢ|t].

The Bid-Ask Spread at time t is denoted by Σ(t)=A(t)−B(t). Calculation shows that this spread is

$$\sum ( t ) = \frac{μ {P}_{g} ( t )}{ɛ + μ {P}_{g} ( t )} ( {S}_{i} - E [ {S}_{i} \vert t ] ) + \frac{μ {P}_{b} ( t )}{ɛ + μ {P}_{b} ( t )} ( E [ {S}_{i} \vert t ] - {S}_{i} ) \qquad ( 4 )$$

The first term in the spread equation is the probability that a buy is an information-based trade times the expected loss to an informed buyer, and the second is a symmetric term for sells. The spread for the initial quotes in the period, Σ, has a particularly simple form in the natural case in which good and bad events are equally likely. That is, if δ=1−δ then

$$\sum = \frac{α μ}{α μ + 2 ɛ} ( {\overline{S}}_{i} - {\underline{S}}_{i} ) \qquad ( 5 )$$

An important component of this model is the probability that an order is from an informed trader, which is called PIN. It is straightforward to show that the probability that the opening trade in a period is information-based is given by

$$PIN = \frac{αμ}{α μ + 2 ɛ} \qquad ( 6 )$$

where αμ+2ε is the arrival rate for all orders and αμ is the arrival rate for information-based orders. PIN is thus a measure of the fraction of orders that arise from informed traders relative to the overall order flow, and the spread equation shows that it is the key determinant of spreads.

These equations illustrate the idea that liquidity providers need to correctly estimate PIN in order to identify the optimal levels at which to enter the market. An unanticipated increase in PIN will result in losses to those liquidity providers who do not adjust their prices.

### Metric Calculation

FIG. 2 is a flow chart of a method 200 of calculating the VPIN informed trading metric, using the system 100 of FIG. 1, according to an illustrative embodiment of the invention. The method 200 begins with the system 100 receiving trading data associated with one or more securities (step 202). The data may be preprocessed, for example, by a feed handler 104 or other process before the data is analyzed to calculate the informed trading metric.

Next, for a given security, from the total volume of units traded as indicated by the trading data, the metric calculator 110 selects the minimum number of trades that add up to at least a predetermined number of units of the security (step 204). If the number of units traded is greater than the predetermined number, any suitable sampling process may be used to select the desired number of units traded. Of particular note, the selected volume of units traded need not be filled with full complete trades. That is, the selected volume of units may include only a portion of one or more trades of the security, if selecting a portion of a trade is necessary to achieve the desired total volume.

Next, the traded units are sorted in time-order of trade execution and are divided into a predetermined number of equal volume sets, also referred to as buckets (step 206). Again, the units traded within a given trade may be split into different sets if needed to achieve the desired equal volume division of traded units. For example, if the predetermined volume of traded units included 10,000 units of the security, the volume may be divided into 10 sets (or buckets) of 1,000 traded units.

For each set of traded units, the metric calculator 110 identifies each traded unit as being associated with a buy transaction or a sale transaction (step 208). In one embodiment, if traded units are identified as buys or sells in the data arriving to the metric calculator 110 this designation is used by the calculator. If traded units are not identified as buys and sells then the metric calculator 110 analyzes the trades to classify them as buy or sell transactions.

In one embodiment, the metric calculator 110 aggregates trades over short time or volume intervals (denoted respectively “time bars” and “volume bars”) and then uses the standardized price change between the beginning and end of each interval to determine the percentage of buy and sell volume per time bar or volume bar. Aggregation mitigates the effects of order splitting and using the standardized price change allows volume classification in probabilistic terms (referred to herein as “bulk classification”). In one specific implementation, the metric calculator 110 calculates buy and sell volumes (V_{τ}^{B} and V_{τ}^{X}) using one-minute time bars, though other duration time aggregations (e.g., 10 seconds, 2 minutes, or 5 minutes) may be employed without departing from the scope of the invention. Examples of volume bars would be one-tenth or one-twentieth of a volume bucket. The appropriate length of the time bar or volume bar size will depend in part on the rate of trades for the particular asset class being assessed. The buy and sell volumes are calculated as follows. Let

$${V}_{τ}^{B} = {\sum }_{i = t ( τ - 1 ) + 1}^{t ( τ )} {V}_{i} \cdot Z ( \frac{{P}_{i} - {P}_{i - 1}}{{σ}_{Δ P}} ) \\ {V}_{τ}^{S} = {\sum }_{i = t ( τ - 1 ) + 1}^{t ( τ )} {V}_{i} \cdot [ 1 - Z ( \frac{{P}_{i} - {P}_{i - 1}}{{σ}_{Δ P}} ) ] = V - {V}_{τ}^{B} \qquad ( 7 )$$

where t(τ) is the index of the last bar included in the τ volume bucket, Z is the CDF of the standard normal distribution and σ_{ΔP} is the estimate of the standard derivation of price changes between bars. The metric calculator 110 splits the volume in a bar equally between buy and sell volume if there is no price change from the beginning to the end of the bar. Alternatively, if the price increases, the volume is weighted more toward buys than sells and the weighting depends on how large the price change is relative to the distribution of price changes.

An important difference between bulk classification and prior classification methodologies is that the prior methods sign the entire volume as either buy or sell, whilst the former signs a fraction of the volume as buys and the remainder as sells. In other words, prior classification processes provide a discrete classification, while the bulk classification process is continuous and differentiable. This means that even in the extreme case that a single time bar fills a volume bucket, volume may still be perfectly balanced according to bulk classification (contingent on

$$\frac{{P}_{i} - {P}_{i - 1}}{{σ}_{Δ P}} ) .$$

This methodology will misclassify some volume. The goal is not to correctly classify each individual trade, but rather to develop an indicator of overall trade imbalance that is useful for creating a measure of toxicity. Time bars are used in an attempt to allow time for the market price to adjust to the trade direction information that is recovered through bulk classification.

In other embodiments, the metric calculator 110 uses one of many standard approaches which are well known in the art to classify trades. For example, in another implementation, a unit is associated with a buy transaction if one of two conditions are met:
1) The per unit price of the trade including the unit exceeded the per unit price of the immediately preceding trade; or
2) The per unit price of the trade including the unit equaled the per unit price of the immediately preceding trade, and the immediately preceding trade was identified as a buy transaction.

All traded units that are not identified as being associated with buy transactions are identified, by default, as being associated with sell transactions.

After all units in a given set of traded units are identified as being associated with a buy or sell transaction (step 208), the metric calculator 110 calculates for the set the absolute value (i.e., magnitude) of the difference between the volume of traded units associated with buy transactions, V_{b}, and the volume of traded units associated with sell transactions, Vₛ (step 210). This value, i.e., the absolute values of Vₛ−V_{b}, for a given set of trades, is referred to herein a set order imbalance, or OIᵢ. After set order imbalances are calculated as described above for each set of traded units, the metric calculator 110 calculates a total order imbalance, OI_{τ}, equal to the sum of the set order imbalances OIᵢ (step 212). Finally, the metric calculator 110 sets the VPIN informed trading metric equal to the ratio of OI_{τ} to the total volume of traded units selected for analysis (i.e., the predetermined volume of traded units referred to in relation to step 204) (step 214). Written differently:

$$\begin{matrix}{OI}_{τ} = {V}_{τ}^{B} - {V}_{τ}^{S} & ( 8 ) \\ VPIN = \frac{{\sum }_{τ = 1}^{n} \vert {OI}_{τ} \vert}{nV} = \frac{{\sum }_{τ = 1}^{n} \vert {V}_{τ}^{S} - {V}_{τ}^{B} \vert}{nV} , & ( 9 )\end{matrix}$$

where, τ serves as a set index, n is the number of sets of trade units used, and V is the per set volume. In one implementation, n is equal 50. In alternative implementations, n may be equal to 25, 75, 100, or any other integer number of buckets, without departing from the scope of the invention. V may range anywhere from 100-1,000,000 traded units depending on the level of trading expected for the particular asset class being assessed.

Alternatively, the metric calculator may employ the following formula to calculate the VPIN informed trading metric:

$$\begin{matrix} VPIN = \frac{E [ \vert {V}_{τ}^{S} - {V}_{τ}^{B} \vert ]}{V} , \\ where & ( 10 ) \\ E [ \vert {V}_{{ }^{τ}}^{S} - {V}_{τ}^{B} \vert ] = σ \sqrt{\frac{2}{π}} {e}^{( - \frac{{( E [ {V}_{τ}^{S} - {V}_{τ}^{B} ] )}^{2}}{2 {σ}^{2}} )} + E [ {V}_{τ}^{S} - {V}_{τ}^{ B} ] [ 1 - 2 Z ( - \frac{E [ {V}_{τ}^{S} - {V}_{τ}^{B} ]}{σ} ) ] & ( 11 ) \\ E [ {V}_{τ}^{S} - {V}_{τ}^{B} ] \approx \frac{1}{n} {\sum }_{τ = L - n + 1}^{L} ( {V}_{τ}^{S} - {V}_{τ}^{B} ) & ( 12 ) \\ {σ}^{2} = {E [ {V}_{τ}^{S} - {V}_{τ}^{B} - E [ {V}_{τ}^{S} - {V}_{τ}^{B} ] ]}^{2} \approx \frac{1}{n} {\sum }_{τ = L - n + 1}^{L} {( {V}_{τ}^{S} - {V}_{τ}^{B} - \frac{1}{L} {\sum }_{τ = L - n + 1}^{L} ( {V}_{τ}^{S} - {V}_{τ}^{B} ) )}^{2} ) & ( 13 )\end{matrix}$$

and Z(x) is the cumulative standard normal distribution. L corresponds to the number of the bucket of trades collected, i.e., the sample length. Although this equation is theoretically more accurate, values obtain from the simpler expression (Eqs. 8 and 9) are extremely close to the ones derived from Eqs. (10)-(13).

When generating a next value for the VPIN informed trading metric, in one embodiment, the metric calculator 110 discards the earliest set of trades and adds a new set of trades based on more recent trading data. The number of traded units included in the newly added set is equal to the number of traded units in each of the remaining sets, such that the total volume of traded units across all sets is again equal to the predetermined volume of traded units. In an alternative embodiment, the metric calculator 110 may discard all prior sets of traded units and generate new sets of traded units based on more recent trading data. The units traded in the new data sets may, but need not, include traded units of the security that were included in the previous data sets.

Several applications of informed trading metrics are described below based on the use of the VPIN metric. Such applications can also be implemented based on other informed trading metrics. One particularly useful class of informed trading metrics is the order imbalance metrics. Order imbalance metrics relate to the relative volume of buy transactions in the market in relation to the volume of sell transactions. VPIN is one such metric. Other order imbalance metrics suitable for use with the above described applications include, without limitation, raw order imbalance, a VPIN_BUY metric, a VPIN_SELL metric, a forecasted VPIN, or a cumulative distribution function of any of the foregoing. Each is described further below.

The most straightforward of the order imbalance metrics is the raw order imbalance metric. It is set forth above as Equation 8, and is one of the parameters that goes into calculating VPIN. In various implementations, the raw order imbalance metric can be calculated across multiple, equally sized volume buckets, either as whole, or by dividing each volume bucket into multiple time or volume bars.

The VPIN_BUY metric and VPIN_SELL metrics are similar to the VPIN metric, but they single out the volume associated with buy and sell transactions, respectively. That is, for a plurality of equally sized volume buckets, VPIN_BUY, also denoted as VPIN_{τ}^{B}, is equal to the sum of the volume of buy transactions for the volume buckets having more buy transactions than sell transactions, divided by the total number of traded units included across the plurality of all volume buckets:

$${VPIN}_{τ}^{B} = \frac{{\sum }_{i = τ - n + 1}^{τ} [ {V}_{i}^{B} - {V}_{i}^{S} \vert {V}_{i}^{B} > {V}_{i}^{S} ]}{nV} \qquad ( 14 )$$

Similarly, VPIN_SELL, also denoted as VPIN_{τ}^{S}, is equal to the sum of the volume of sell transactions for the volume buckets having more sell transactions than buy transactions, divided by the total number of traded units included across the plurality of volume buckets:

$${VPIN}_{τ}^{S} = \frac{{\sum }_{i = τ - n + 1}^{τ} [ {V}_{i}^{S} - {V}_{i}^{B} \vert {V}_{i}^{S} > {V}_{i}^{B} ]}{nV} . \qquad ( 15 )$$

In addition to current order imbalance metrics, useful order imbalance metrics include forecasted future order imbalance metrics. For example, the forecasted value for VPIN one volume bucket ahead in the future can be derived as follows:

$${VPIN}_{τ + 1} = \frac{1}{L \cdot V} {\sum }_{i = τ - L + 2}^{τ + 1} \vert {OI}_{i} \vert . \qquad ( 16 )$$

However, OI_{τ+1} is not known. It can be forecast, however, according to the following equation:

$$\vert {OI}_{τ + 1} \vert = {VPIN}_{τ} ( 1 - {\hat{β}}_{1} ) V + \vert {OI}_{τ} \vert ( \frac{1}{L} + {\hat{β}}_{1} ) - \frac{\vert {OI}_{τ - L} \vert}{L} + {ɛ}_{τ + 1} \qquad ( 17 )$$

where,

$${\hat{β}}_{1} = \hat{ρ} [ \vert {OI}_{i} \vert , \vert {OI}_{i - 1} \vert ] \sqrt{\frac{Var ( \vert {OI}_{i} \vert )}{Var ( \vert {OI}_{i - 1} \vert )}} . \qquad ( 18 )$$

A future raw order imbalance metric can then be calculated merely by multiplying the forecasted VPIN value by the total sample volume.

### Metric Applications

As discussed further below, research by the inventors has demonstrated that the VPIN informed trading metric provides useful predictive information about future behavior of market prices and their volatility. For example, the inventors have found that the VPIN informed trading metric calculated according to the process set forth above would have successfully anticipated the market conditions that led to the “Flash Crash”, i.e., the market crash on May 6, 2010, which at that time represented the second largest point swing and the biggest one-day point decline on an intraday basis in the history of the Dow Jones Industrial Average. In a recent study by the CIFT division of the Lawrence Berkeley National Laboratory (U.S. Department of Energy), a team of scientist has reproduced these finding and concluded that “[VPIN gave] the strongest early warning signal known to us at this time” in anticipation to the May 6, 2010 “flash crash”.

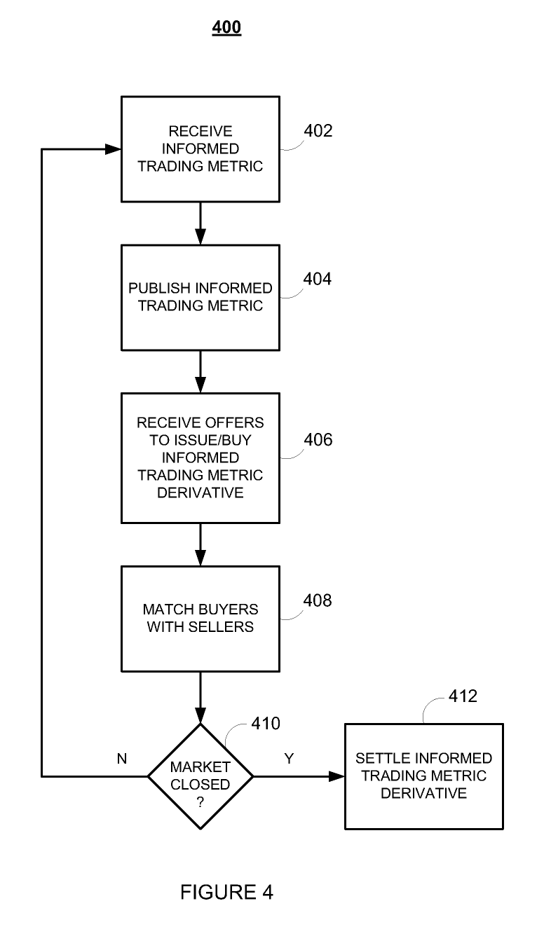

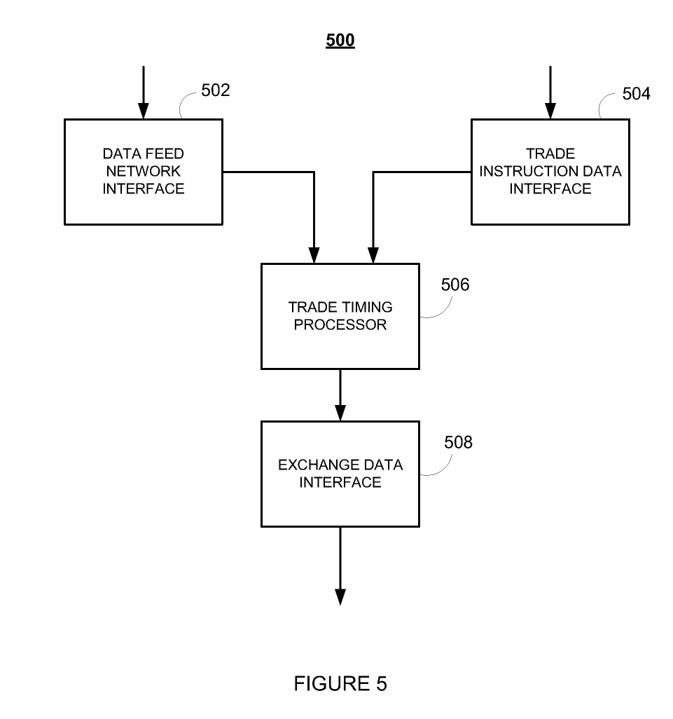

Informed trading metrics, such as VPIN, also enables the prediction of future price volatility. Thus, knowledge by the investment community of the VPIN informed trading metric values in the days and hours prior to the crash would have enabled traders to place hedges and take a variety of actions that may very well have staved off the crash. The system and methods described below in relation to FIGS. 3 and 4 are illustrative of systems and methods that would enable such hedging. Various other systems and methods for exploiting an informed trading metric such as VPIN or a function of VPIN (e.g., the cumulative distribution function of VPIN) are described in FIGS. 5-10.

FIG. 3 is a block diagram of a securities exchange system 300 suitable for using the VPIN informed trading metric calculated by the system of FIG. 1 to facilitate trades of derivative contracts with the informed trading metric serving as the underlying. The exchange system 300 includes a network gateway 302, a data feed interface 304, a trading network interface 306, a publication server 308, a matching processor 310, and a settlement processor.

The network gateway 302 connects the exchange system 300 to one or more communication networks, such as the Internet or other public or private communications network. In exchange systems 300 coupling to multiple communication networks, the exchange system may include multiple network gateways 302, including one network gateway for obtaining data over the Internet and one or more network gateways coupling the exchange system 300 to high-speed trading networks configured to facilitate high-frequency trading.

The data feed network interface 304 is coupled to the network gateway 302 and is configured for receiving streams of financial data, including the informed trading metric calculated by system 100. The trading network interface 306 is configured to receive requests to buy and sell securities, including requests made on behalf of position takers and those made on behalf of market makers.

The publication server 308 publishes data extracted from the data streams received over the data feed network interface 304 as well as data indicative of trades executed by the exchange. Thus, in one implementation, the publication server may serve as one source of trading data received by system 100 and upon which the VPIN informed-trading metric is calculated.

The matching processor 310 matches buyers to sellers to facilitate the exchange of securities, including, stocks, options and other derivative contracts, including a VPIN informed trading metric-based derivative contract. Hardware and software suitable for use as the matching processor 310 are well known in the art.

The VPIN informed trading-based derivative contract, in one embodiment, would be exchanged by various market participants, such as investment banks, market makers, hedge funds, etc. during the course of a trading day. The contracts would then be redeemable at the end of the day for a value equal to a predetermined function of the end-of-day informed trading metric output by the system 100. For example, in one informed trading metric-based futures contract, the issuer agrees to pay a counterparty $5,000* a deterministic function of end-of-day VPIN informed trading metric value (including e.g., the value of the end-of-day VPIN informed trading metric itself). Based on the value of the metric during the day, as published by the exchange, market participants can offer to buy or sell such contracts at various prices depending on their expectation as to the future value of the metric, or merely to hedge against losses resulting from undesirable trades were the metric to trend in a particular direction. In alternative embodiments, the VPIN informed trading metric-based derivative contracts may be redeemable at times other than the end of a trading day upon which they are sold. For example, the derivative contract may provide for settlement after a predetermined number of hours, days, weeks, or months.

The settlement processor 312 is used by the exchange system 300 to settle various transactions effectuated or facilitated by the exchange system 300. For example, the settlement processor 312 may be employed to settle the VPIN informed trading metric-based derivative contracts described above.

The VPIN informed trading-based derivative contract can be used to achieve a number of goals. For example, the VPIN informed trading-based derivative contract provides a mechanism by which all market participants can reach a market-consensus on the prevailing toxicity levels, and allow for a transfer of risks associated with it. This is not only interesting to liquidity providers, but also to investors.

In addition, the contract provides a risk management tool for market makers. One of the advantages of hedging with the contract is that it will allow market makers to continue providing liquidity, even if toxicity exceeds the levels originally expected. This could largely mitigate the kind of liquidity evaporation witnessed on May 6, 2010. For example, a liquidity provider might opt to purchase the contract as a hedge if their inventory grows over a threshold level.

In another example, the contract can help to monitor the level of ‘pain’ that is being inflicted to market makers on a particular day. Since the informed trading metric is able to anticipate a liquidity-driven collapse, it would be preferable to base circuit-breakers on the informed trading-based derivative contract rather than simply on prices (i.e., shutting the market after the collapse, to most participants' dismay). For example, regulators could order a temporary market halt if the price of the informed trading-based derivative contract goes over a predetermined cumulative probability threshold, for example, 90%. The contract also serves as a desirable security for the volatility arbitrage business.

Each of the components of the exchange system 300, may, in various embodiments, be implemented in any suitable combination of computer hardware and software. For example, each component or portions thereof may be implemented as computer readable instructions stored on a non-transitory computer readable medium, such as a magnetic disk, optical disk, integrated circuit memory, or other form of non-transitory memory device. The computer readable instructions cause a computer processor, upon execution, to carry out at least the methodology described further in relation to FIG. 4.

FIG. 4 is a flow chart of a method 400 for facilitating the exchange of informed trading metric-based derivative contracts, according to an illustrative embodiment of the invention. As used herein, an “informed trading metric-based derivative contract” is any financial instrument that has a value determined by a formula that includes (directly or indirectly) an informed trading metric, such as the VPIN metric, as an input parameter, including, without limitation, futures contracts, options, and various OTC traded products or structures. The method begins with an exchange system, such as exchange system 300, receiving informed trading metric data (step 402). The exchange system 300 then publishes the metric to inform market participants of its current value (step 404). The exchange system may publish the value of the metric directly, or it may publish the exchange price of the informed trading metric-based derivative contract.

The exchange system 300 then receives orders to sell and orders to buy informed trading metric-based derivative contract (step 406). The offers include both a volume of units of the derivative contracts offered to be bought or sold, as well as corresponding bid and ask prices. The exchange system feeds these offers into the matching processor 310, which matches issuers with buyers (step 408), and facilitates the issuance of the derivative contracts. The process continues until the market closes (decision block 410), at which time the exchange system 300 settles the informed trading metric-based derivative contracts based on the end-of-day informed trading metric value.

FIG. 5 is a functional block diagram of a system 500 for a broker-dealer to time the execution of trades based on knowledge of a current value of an informed trading metric, such as the VPIN metric, according to an embodiment of the invention. In alternative embodiments, the system employs a function (e.g., a cumulative distribution function) of VPIN as the informed trading metric. Applicants have determined that trading securities at times having high informed trading metric values is likely to be disadvantageous to most liquidity providers and other passive traders, as it suggests that there are entities trading in the market with better knowledge of the appropriate price for a security than the other market participants. Thus, market participants without this knowledge, for example, members of the general public, market makers, and many institutional investors, are at a disadvantage and are more likely to sell for too low a price or buy for too high a price. The system 500 mitigates these risks by delaying instructions to execute trades in adverse trading conditions. It also can accelerate instructions to execute trades when the informed trading metric is below a pre-specified level, indicating a reduced risk of adverse trading conditions.

The system includes a data feed network interface 502, a trade instruction data interface 504, a trade timing processor 506, and an exchange data interface 506. The data feed network interface is a network interface designated to receive streamed financial securities feeds, including a data feed delivering informed trading metric data. The informed trading metric data may be in the form of informed trading metric values calculated by the system 100, future prices for the informed trading metric-based derivative contracts published by the exchange system 300, and/or recently quoted buy and sell prices of informed trading metric-based derivative contracts exchanged through system 300.

The trade instruction data interface 504 is a network interface designated for receiving securities trading instructions from investors served by a broker-dealer. The trade instruction data interface 504 may be a network card configured for receiving trades submitted through a web interface and/or a proprietary trading platform offered by the broker-dealer.

The trade timing processor 506 is a computer processor that serves as a gateway to the exchange data interface 508, through which market orders are placed with an exchange system, such as exchange system 300. The trade timing processor 506 is configured to identify informed trading metric limitations in submitted orders, i.e. orders which incorporate a threshold informed trading metric value above which the order will be withheld until the informed trading metric value falls below the threshold or an expiration date associated with the order passes. In alternative embodiments, the trade timing processor 506 is configured to utilize a default informed trading metric threshold. In such embodiments, all trades will be halted unless specifically authorized to proceed, if the informed trading metric falls below the default value.

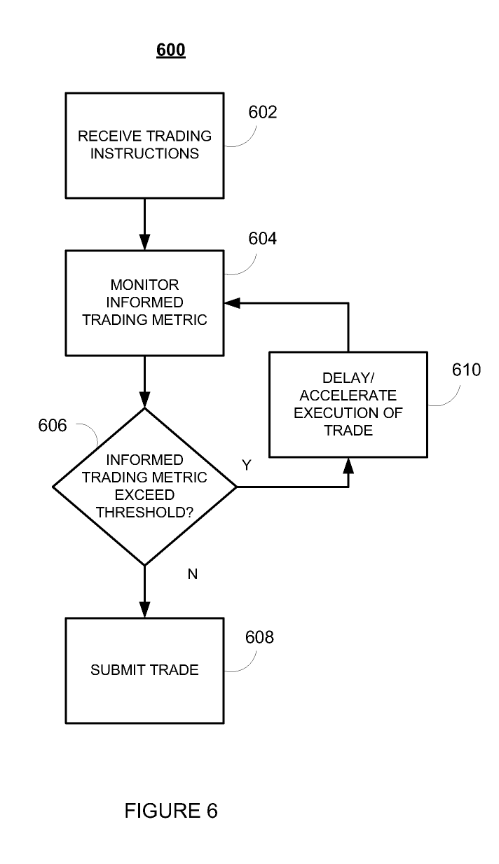

Each of the components of the broker system 500, may, in various embodiments, be implemented in any suitable combination of computer hardware and software. For example, each component or portions thereof may be implemented as computer readable instructions stored on a non-transitory computer readable medium, such as a magnetic disk, optical disk, integrated circuit memory, or other form of non-transitory memory device. The computer readable instructions cause a computer processor, upon execution, to carry out at least the methodology described further in relation to FIG. 6.

FIG. 6 is a flow chart of a method 600 of timing execution of trading instructions based on an informed trading metric, such as the VPIN metric or a function of VPIN, according to an illustrative embodiment of the invention. The method begins with a broker system 500 receiving instructions to place an order to buy or sell a security (step 602). The broker system 500 continuously monitors informed trading metric data (step 604). As discussed in relation to FIG. 5, the broker system 500 may monitor either the value of the current informed trading metric, the price of an informed trading metric-based security, and/or actual prices recently quoted for the informed trading metric-based derivative contracts. If the informed trading metric data falls within a predetermined interval or an interval indicated in the trading instructions (decision block 606), the broker system 500 submits the order to an exchange for matching and execution at standard speed (step 608). If the informed trading metric data exceeds the default threshold or the threshold indicated in the trading instructions (decision block 606), the broker system 500 delays the execution of the market order (step 610) until the value of the metric falls sufficiently. If the informed trading metric data falls below the default threshold or the threshold indicated in the trading instructions (decision block 606), the broker system 500 accelerates the execution of the market order (step 610) until the value of the metric rises sufficiently.

In an alternative embodiment, broker systems, instead of controlling the timing of submitting a trade to an exchange, include informed trading metric threshold information in the orders submitted to the exchange, requiring the exchange to adhere to the instructions.

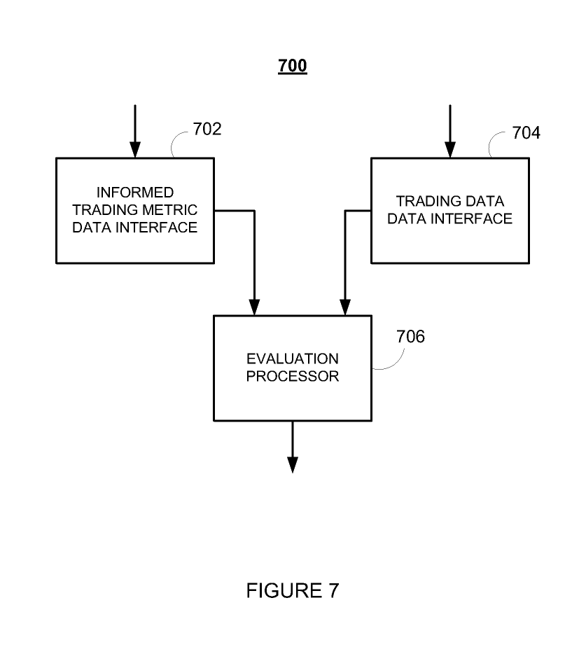

FIG. 7 is a block diagram of an analyst system 700 suitable for evaluating the trading behavior of a market participant, according to an illustrative embodiment of the invention. The system 700 includes an informed trading metric data interface 702 for receiving informed trading metric data and a trading data data interface 704. The trading data data interface 704 receives data indicative of trades executed by various market participants, including, e.g., brokers and fund managers. An evaluation processor 704 processes the informed trading metric data and the trading data to determine the propensity for the market participant to execute trades at various levels of the informed trading metric. Such information would allow investors to invest in funds or through brokers that know how to adjust the timing of their execution in order to avoid adverse selection.

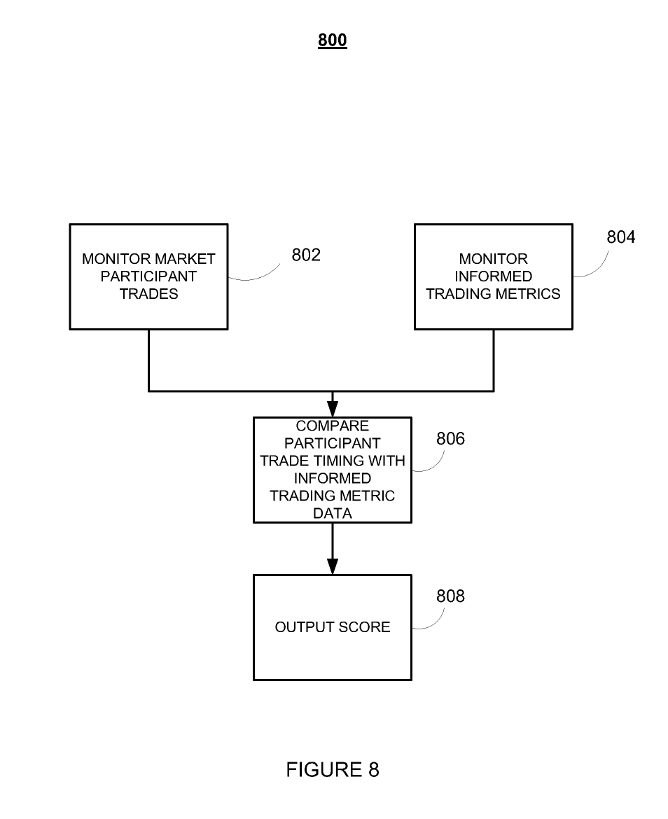

Each of the components of the analyst system 700, may, in various embodiments, be implemented in any suitable combination of computer hardware and software. For example, each component or portions thereof may be implemented as computer readable instructions stored on a non-transitory computer readable medium, such as a magnetic disk, optical disk, integrated circuit memory, or other form of non-transitory memory device. The computer readable instructions cause a computer processor, upon execution, to carry out at least the methodology described further in relation to FIG. 8.

FIG. 8 is a flow chart of a method 800 for evaluating the performance of a market participant in relation to the informed trading metric, such as the VPIN metric or a function of VPIN. The method 800 begins with an analyst system, such as the analyst system 700 of FIG. 7 monitoring, receiving, and storing data indicative of trades executed by one or more market participants being evaluated (step 802). The analyst system 800 also monitors informed trading metric data (step 804). The system 800 then compares the timing of the market participants' trades in relation to the value of the informed trading metric at the time of the trades (step 806). The system 800 then outputs a score that is a function of the comparison (step 808). Market participants are assigned a better score if their trades tend to occur at times at which the informed trading metric value is low. Market participants are assigned a worse score if their trades tend to occur at times at which the informed trading metric value is adversely high.

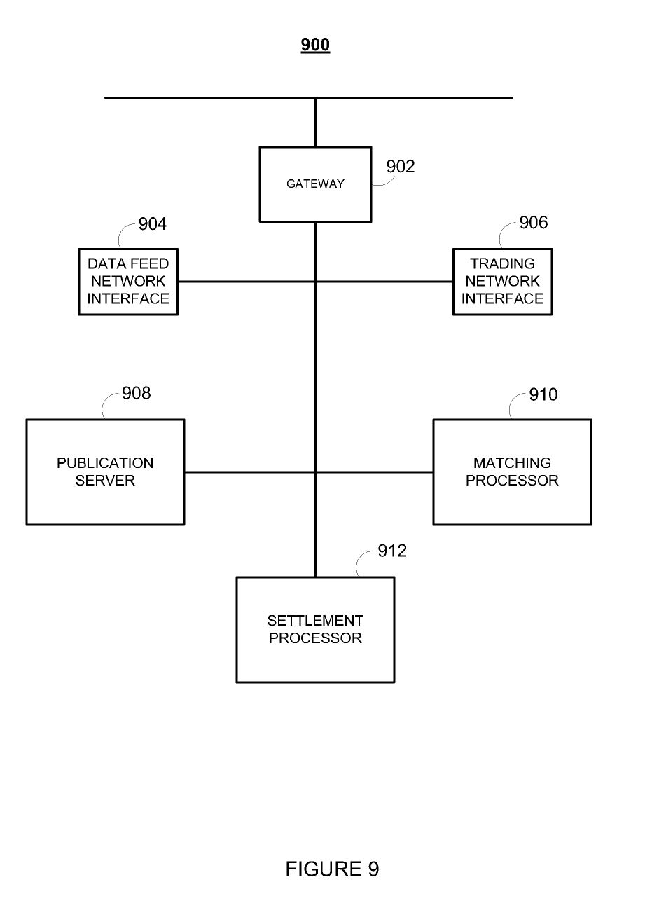

FIG. 9 is a functional block diagram of an alternative securities exchange system 900 suitable for using the informed trading metric (e.g., the VPIN metric or a function of VPIN) calculated by the system of FIG. 1 for controlling the pace at which orders are matched based on knowledge of a current value of an informed trading metric, according to an embodiment of the invention. The exchange system 900 supports market liquidity by delaying execution of predatory trading activity aimed at leveraging large information disparities existing in the market as measured by the informed trading metric. In one embodiment, the exchange system is configured to adjust the fraction of the buy orders versus sell orders it matches based on the value of an informed trading metric, such as the informed trading metrics described above. Such an exchange system not only penalizes predatory behavior, but rewards liquidity providers, thus reducing their incentive to withdraw liquidity from the markets under adverse circumstances. The system 900 may be configured either by exchange operators, or at the direction of regulators. For example, the pacing control provided by the system 900 may take the place of or supplement “circuit breakers” imposed by regulators that require exchanges to halt trading in response to unusually large losses in market value.

The exchange system 900 includes a network gateway 902, a data feed interface 904, a trading network interface 906, a publication server 908, a matching processor 310, and a settlement processor.

The network gateway 902 connects the exchange system 900 to one or more communication networks, such as the Internet or other public or private communications network. In exchange systems 900 coupling to multiple communication networks, the exchange system may include multiple network gateways 902, including one network gateway for obtaining data over the Internet and one or more network gateways coupling the exchange system 900 to high-speed trading networks configured to facilitate high-frequency trading.

The data feed network interface 904 is coupled to the network gateway 902 and is configured for receiving streams of financial data, including the informed trading metric calculated by system 100 (though alternatively, the exchange system 900 could calculate the informed trading metric itself based on the financial data it receives via the data feed network interface 904). The trading network interface 906 is configured to receive requests to buy and sell securities, including requests made on behalf of position takers and those made on behalf of market makers.

The publication server 908 publishes data extracted from the data streams received over the data feed network interface 904 as well as data indicative of trades executed by the exchange. Thus, in one implementation, the publication server may serve as one source of trading data received by system 100 and upon which the informed-trading metric is calculated.

The matching processor 910 matches buyers to sellers to facilitate the exchange of securities, including, stocks, options and other derivative contracts. Basic hardware and software suitable for use as the matching processor 910 are well known in the art. However, unlike standard matching processor hardware and software, the matching processor 910 is specifically configured to alter its matching behavior based on the level of the information disparity, as indicated by the informed trading metric, existing in the market at any given time. The matching processor 910 is configured to variably bias the rate at which it matches buy orders versus sell orders in order to combat potential predatory behavior during times of large information disparities. In such situations, the matching engine would favor matching buy orders as opposed to sell orders. For example, upon receiving a high informed trading metric, the matching processor 910 may alter its execution logic such that 60%, 70%, 80% or any other percentage greater than 50% of the orders it matches are buy orders and the remaining matched orders are sell orders. The degree of favoritism shown to buy orders may vary depending on the exact value of the informed trading metric. In contrast, in times of lower information disparity, the matching processor 910 treats buy orders and sell orders equally, and in some cases may even favor sell orders favorably over buy orders. The ultimate goal is to gradually penalize misbehavior rather than allow it to compound to the point of generating a financial crash or overwhelming the exchange's computational resources (like in a cyber-attack).

The settlement processor 912 is used by the exchange system 900 to settle various transactions effectuated or facilitated by the exchange system 900.

In alternative embodiments, instead of immediately altering the behavior of the matching engine upon receiving a new informed trading metric value, the system 900 may be configured to only alter matching behavior after the informed trading metric has exceed a particular value for a threshold period of time, thereby avoiding reacting to false positives.

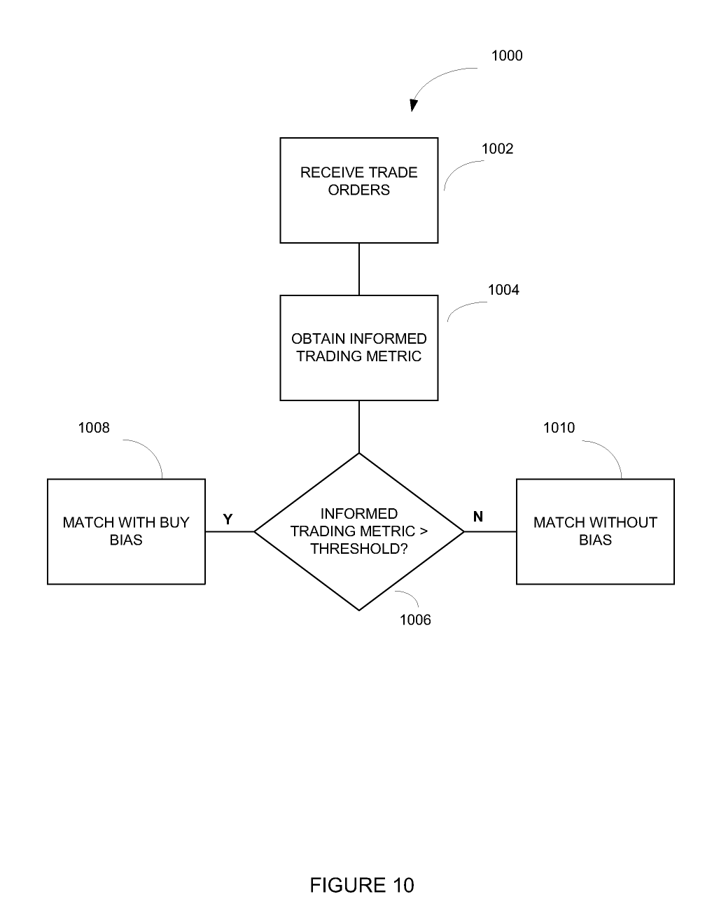

Each of the components of the exchange system 900, may, in various embodiments, be implemented in any suitable combination of computer hardware and software. For example, each component or portions thereof may be implemented as computer readable instructions stored on a non-transitory computer readable medium, such as a magnetic disk, optical disk, integrated circuit memory, or other form of non-transitory memory device. The computer readable instructions cause a computer processor, upon execution, to carry out at least the methodology described further in relation to FIG. 10.

FIG. 10 is a flow chart of a method 1000 of controlling trade match rates at an exchange, according to an illustrative embodiment of the invention. The method includes receiving buy and sell orders (step 1002), obtaining the current value for an informed trading metric, e.g., the VPIN metric (step 1004), determining whether the informed trading metric value exceeds an informed trading threshold (decision block 1006), and either matching orders with a buy bias (step 1008) or matching orders without a bias (step 1010) based on the determination. In alternative embodiment, the method includes determining a “buy bias” according to a continuous function of the informed trading metric. The informed trading metric may be obtained (step 1004) either via a communications link, for example from system 100, or it may be calculated locally based on received trading data. In various alternative implementations, the method 1000 may employ a “sell bias” instead of a buy bias to achieve similar results. In addition, alternative embodiments, the method 1000 may only alter the buy or sell bias after the informed trading threshold has been exceeded for more than a predetermined period of time.

As described above, VPIN can be decomposed into a separate VPIN_BUY and VPIN_SELL metrics, which indicate the degree of informed trading on both the buy and sell side of transactions. These metrics can be particularly useful at identifying the activity of what are referred to as “predatory” traders. Predatory traders are a special kind of informed traders that use “predatory” algorithms to execute their trades. Rather than possessing exogenous information yet to be incorporated in the market price, predatory traders know that their endogenous actions are likely to trigger a microstructure mechanism, with a foreseeable outcome. Examples include of predatory trading algorithms include
Quote stuffing: Overwhelming an exchange with messages, with the sole intention of slowing down competing algorithms.
Quote dangling: Sending quotes that force a squeezed trader to chase a price against her interests.
Pack hunting: Predators hunting independently become aware of each others activities, and form a pack in order to maximize the chances of triggering a cascading effect.
   Monitoring a metric equal to the ratio of the VPIN_BUY or VPIN_SELL metric to VPIN, i.e.:

$$\begin{matrix}\frac{{VPIN}_{τ}^{B}}{{VPIN}_{τ}} , \\ or & ( 19 ) \\ \frac{{VPIN}_{τ}^{S}}{{VPIN}_{τ}} , & ( 20 )\end{matrix}$$

can provide information about the presence of predatory algorithms (and other forms of informed trading) and its impact. For example, a ratio of ½ suggests an even distribution of flow toxicity (generated e.g., by a predatory algorithm). Such activity has a decreased likelihood in significantly and adversely affecting the market as the predatory traders cannibalize each other. On the other hand, ratios approaching 1 or 0 are suggest a significant toxicity on the buy side or sell side. This imbalance can be counteracted by adjusting the buy or sell bias as described above. For example, if the Value of VPIN is disproportionately waited towards VPIN_BUY (i.e., as

$$\frac{{VPIN}_{τ}^{B}}{{VPIN}_{τ}} - 1 or as \frac{{VPIN}_{τ}^{S}}{{VPIN}_{τ}} -> 0 )$$

the sell bias can be raised (or the buy bias lowered), favoring sell transactions, delaying execution of the predatory buy transactions. At the limit, only sell transactions may be allowed. Similarly, the sell bias can be raised (or the buy bias lowered) in response to detecting a VPIN value dominated by VPIN_SELL. As the predatory traders are forced to hold their positions longer due to the delay in exchange processing, they are faced with an increased likelihood of experiencing losses. This forces the predatory traders to cease activity returning exchange activity to normal. The use of such a “dynamic circuit breaker”, to incrementally adjust activity based on the level and direction (i.e., buy or sell) toxicity can avoid the need for hard circuit breakers at an exchange that would otherwise halt all trading if triggered.

### Empirical Results

To explore the accuracy and predictive capability of the informed trading metric described above, the inventors evaluated the VPIN metric for the period beginning Jan. 1, 2008 and ending Jun. 6, 2011. Each calendar year was divided into an average of 50 equal volume buckets using the methodology discussed above in relation to FIG. 2. FIG. 11 is a plot of the results of this calculation in relation to the value of the E-mini S&P500 future contract and to the CDF of the VPIN metric. The VPIN metric is generally stable, although it clearly exhibits substantial volatility. Of particular importance, the VPIN metric reached its highest level for this sample on May 6, 2010, the day of the flash crash. It also peaked during a more recent episode of extreme toxicity, which occurred in the aftermath of the Tohoku Japanese earthquake of Mar. 11, 2011 that eventually led to the meltdown of the Fukushima nuclear reactor. Although the major Tohoku earthquake and tsunami took place in the early morning of Mar. 11, 2011, the S&P500 didn't experience a large move until the subsequent Fukushima nuclear crisis unfolded on Mar. 14, 2011. That day the S&P500 registered another extreme level of order flow toxicity. Unlike on May 6, 2010, the March 14, 2011 crash occurred with light volume, during the night session (from 6 pm to 11 pm EST). After only 287,360 contracts had been traded, the index had lost approximately 2.5% of its value, illustrating that flow toxicity also occurs in instances of reduced trade intensity

The inventors also analyzed the applicability of the VPIN metric to other asset classes, for example commodities. Crude oil is the most heavily traded commodity. Its strategic role in the world's economy makes it ideal for placing geopolitical and macroeconomic wagers. Energy futures are also a venue in which market makers face extreme volatility in order flows. To demonstrate the applicability of the VPIN metric to commodities, the inventors calculated the VPIN metric for crude oil futures contracts for the same Jan. 1, 2008 to Jun. 6, 2011 time period. As shown in FIG. 12, the highest flow toxicity reading, i.e., the highest value of the VPIN metric, for this contract occurred on May 6, 2010. Such behavior is consistent with the fact that while the problems on May 6^{th} were not energy related, these markets were affected by the contagion of liquidity and toxicity conditions across markets. Other than the day of the flash crash, the next highest toxicity levels for this contract occurred on May 5, 2011 and Dec. 9, 2009.

In early May 2011, the CFTC reported the largest long speculative position among crude traders in history. The New York Times attributed these large positions to traders believing that energy prices would ramp up, fueled by the violence sweeping through North Africa and the Middle East. Some of these traders decided to take profits on May 5, 2011. The unwinding of their massive positions led them to seek liquidity from uninformed traders. But as these uninformed traders realized that the selling pressure was persistent, they started to withdraw, which in turn increased the concentration of toxic flow in the overall volume. By 9:53 am the CDF of the informed trading metric crossed the 0.9 threshold, remaining there for the rest of the day. During those few hours, the WTI crude oil index lost over 8%.

On Dec. 9, 2009, the U.S. Department of Energy released inventory numbers that showed gasoline supplies rising to the highest level since April 2009, as well as increasing distillate fuel inventories. This event, combined with a stronger dollar, seems to have reduced the demand for oil futures. As a result, that day, the WTI crude oil index lost around 5.5% of its value.

Similar performance was observed in relation to applying the VPIN informed trading metric to trades of other assets, including currency, natural gas, Treasuries, and gold futures.

In addition to Applicants' empirical results demonstrating the predictive value of VPIN, the results of have been independently validated by the Department of Energy's Office of Science by researchers at Lawrence Berkeley National Laboratory. Their report, “Federal Market Information Technology in the Post Flash Crash Era: Roles for Supercomputing”, by Bethel et al., found that VPIN “is the strongest early warning signal known to us at this time.”

The invention may be embodied in other specific forms without departing from the spirit or essential characteristics thereof.

What is claimed is:

1. A securities exchange system comprising:
a first network interface for receiving a plurality of securities trades, including a plurality of buy transactions and a plurality of sell transactions;
a matching processor for matching the securities trades to market makers, wherein the matching processor is configured to:
obtain a value of an informed trading metric,
determine a buy transaction bias or a sell transaction bias based on the value of the informed trading metric, and
match trades to market makers favoring buy transactions or sell transactions based on the determined buy transaction bias or sell transaction bias, and
a settlement processor for settling matched trades.

2. The securities exchange system of claim 1, wherein the informed trading metric comprises a volume synchronized informed trading metric.

3. The securities exchange system of claim 1, wherein obtaining the informed trading metric comprises calculating, by a processor, the informed trading metric.

4. The securities exchange system of claim 1, wherein the informed trading metric comprises an order imbalance metric.

5. The securities exchange system of claim 1, wherein the informed trading metric comprises a metric equal to the ratio of a total order imbalance to a total order volume.

6. The securities exchange system of claim 5, wherein the total order imbalance comprises a total order imbalance across a plurality of equally sized sets of trades, each having a corresponding set order imbalance.

7. The securities exchange system of claim 1, wherein the informed trading metric comprises a cumulative distribution function of an order imbalance metric.

8. The securities exchange system of claim 1, wherein the informed trading metric comprises a forecasted informed trading metric.

9. The securities exchange system of claim 1, wherein the informed trading metric comprises a buy transaction specific or sell transaction specific order imbalance metric.

10. The securities exchange system of claim 1, wherein determining a buy transaction bias or a sell transaction bias comprises setting a bias value based on a raw value of the informed trading metric.

11. The securities exchange system of claim 1, wherein determining a buy transaction bias or a sell transaction bias comprises setting a bias value based on a time for which the value of the informed trading metric exceeds a threshold value.

12. A method comprising:
Receiving, by an electronic securities exchange, a plurality of securities trades, including a plurality of buy transactions and a plurality of sell transactions;
matching, by the electronic securities exchange, the securities trades to market makers by:
obtaining a value of an informed trading metric,
determining a buy transaction bias or a sell transaction bias based on the value of the informed trading metric, and
matching trades to market makers favoring buy transactions or sell transactions based on the determined buy transaction bias or sell transaction bias, and
settling, by the electronic securities exchange, matched trades.

13. The method of claim 12, wherein the informed trading metric comprises a volume synchronized informed trading metric.

14. The method of claim 12, wherein obtaining the informed trading metric comprises calculating, by a processor, the informed trading metric.

15. The method of claim 12, wherein the informed trading metric comprises an order imbalance metric.

16. The method of claim 12, wherein the informed trading metric comprises a metric equal to the ratio of a total order imbalance to a total order volume.

17. The method of claim 16, wherein the total order imbalance comprises a total order imbalance across a plurality of equally sized sets of trades, each having a corresponding set order imbalance.

18. The method of claim 12, wherein the informed trading metric comprises a cumulative distribution function of an order imbalance metric.

19. The method of claim 12, wherein the informed trading metric comprises a forecasted informed trading metric.

20. The method of claim 12, wherein the informed trading metric comprises a buy transaction specific or sell transaction specific order imbalance metric.

21. The method of claim 12, wherein determining a buy transaction bias or a sell transaction bias comprises setting, by the electronic securities exchange, a bias value based on a raw value of an informed trading metric.

22. The method of claim 12, wherein determining a buy transaction bias or a sell transaction bias comprises setting a bias value based on a time for which the value of the informed trading metric exceeds a threshold value.
